(19) United States
(12) Patent Application Publication
(10) Pub. No.: US 2026/0005737 A1
(43) Pub. Date: Jan. 1, 2026

(54) WIRELESS COMMUNICATION SYSTEM

(71) Applicant: ASUSTeK COMPUTER INC., Taipei (TW)

(72) Inventors: Chien-Ming HSU, Taipei (TW); Chun-Chieh SU, Taipei (TW); Sung-Mao LIAO, Taipei (TW)

(21) Appl. No.: 19/206,188

(22) Filed: May 13, 2025

(30) Foreign Application Priority Data
Jun. 27, 2024 (TW) 113124128

(51) Int. Cl. H04B 7/06; H04W 84/12

(52) U.S. Cl. CPC H04B 7/0602; H04W 84/12

(57) ABSTRACT

A wireless communication system includes: a WLAN module that transmits and receives a first wireless signal through a plurality of first antennas, and a WWAN module that transmits and receives a second wireless signal through a plurality of second antennas. One ends of a switch device are connected to the first antennas and the second antennas, and other ends are connected to the WLAN module and the WWAN module. The WLAN module is electrically connected to the first antennas through the switch device, and the switch device selectively switches the second antennas to be electrically connected to the WLAN module or the WWAN module. When the WWAN module is turned off, the switch device connects the second antennas to the WLAN module, so that the WLAN module selectively transmits and receives the first wireless signal through the first antennas and the second antennas.

### CROSS-REFERENCE TO RELATED APPLICATION

This application claims the priority benefit of Taiwan Application Serial No. 113124128, filed on Jun. 27, 2024. The entirety of the above-mentioned patent application is hereby incorporated by reference herein and made a part of specification.

### BACKGROUND OF THE INVENTION

### Field of the Invention

The disclosure relates to a wireless communication system that increases a receiving and transmitting range of a wireless local area network (WLAN) signal and a wireless wide area network (WWAN) signal.

### Description of the Related Art

With the development of communication technology, an electronic product needs to use antennas when transmitting or receiving a radio frequency signal, and the electronic product needs to support a growing number of types of wireless signals. A notebook computer or a mobile phone is used as an example. A wireless local area network (WLAN) includes corresponding antennas, and a wireless wide area network (WWAN) also includes corresponding antennas. Generally speaking, the configuration of antennas is usually two antennas for the WLAN and two or four antennas for the WWAN, so that the WLAN and the WWAN have their own antennas for receiving and transmitting wireless signals.

When the user enables a Wi-Fi function in the WLAN, a Wi-Fi antenna is to receive and transmit a Wi-Fi signal. When the user enables a 5G/LTE function in the WWAN, the 5G/LTE antenna is to receive and transmit a wireless wide area signal. However, when the user enables the Wi-Fi function and disables the 5G/LTE function, the 5G/LTE antenna is to be idle and is not to be effectively utilized.

### BRIEF SUMMARY OF THE INVENTION

The disclosure provides a wireless communication system, including a plurality of first antennas, a plurality of second antennas, a wireless local area network (WLAN) module, a wireless wide area network (WWAN) module, and a switch device. The WLAN module transmits and receives a first wireless signal through the first antennas, and the WWAN module transmits and receives a second wireless signal through the second antennas. One ends of a switch device are connected to the first antennas and the second antennas, and other ends are connected to the WLAN module and the WWAN module. The WLAN module is electrically connected to the first antennas through the switch device. The switch device selectively switches the second antennas to be electrically connected to the WLAN module or the WWAN module. When the WWAN module is turned off, the switch device connects the second antennas to the WLAN module, so that the WLAN module selectively transmits and receives the first wireless signal through the first antennas and the second antennas.

Based on the above, the disclosure provides a wireless communication system that effectively utilizes idle antennas of the WWAN module without increasing an antenna size and space, and changes the antennas to antennas of the WLAN module to receive and transmit a signal. Therefore, a signal receiving and transmission range of the WWAN signal and the WLAN signal is effectively increased, so as to increase a coverage (a coverage rate) of a wireless network signal.

### BRIEF DESCRIPTION OF THE DRAWINGS

FIG. 1 is a schematic diagram of an architecture of a wireless communication system according to a first embodiment of the disclosure.

FIG. 2 is a schematic diagram of an electronic device provided with four antennas according to an embodiment of the disclosure.

FIG. 3 is a schematic diagram of an electronic device provided with four antennas according to another embodiment of the disclosure.

FIG. 4 is a schematic diagram of an electronic device provided with four antennas according to yet another embodiment of the disclosure.

FIG. 5 is a schematic diagram of an electronic device provided with four antennas according to still another embodiment of the disclosure.

FIG. 6 is a schematic diagram of an architecture of a wireless communication system according to a first embodiment of the disclosure with a wireless wide area network (WWAN) function being disabled.

FIG. 7A is an antenna radiation pattern diagram of a wireless communication system in a Wi-Fi 2.4G environment according to an embodiment of the disclosure.

FIG. 7B is an antenna radiation pattern diagram of a wireless communication system in a Wi-Fi 5G environment according to an embodiment of the disclosure.

FIG. 7C is an antenna radiation pattern diagram of a wireless communication system in a Wi-Fi 6E environment according to an embodiment of the disclosure.

FIG. 8 is a schematic diagram of an architecture of a wireless communication system according to a second embodiment of the disclosure.

FIG. 9 is a schematic diagram of an electronic device provided with six antennas according to an embodiment of the disclosure.

FIG. 10 is a schematic diagram of an electronic device provided with six antennas according to another embodiment of the disclosure.

FIG. 11 is a schematic diagram of an electronic device provided with six antennas according to yet another embodiment of the disclosure.

FIG. 12 is a schematic diagram of an architecture of a wireless communication system according to a second embodiment of the disclosure with a WWAN function being disabled.

FIG. 13 is a schematic diagram of an architecture of a wireless communication system according to a third embodiment of the disclosure.

FIG. 14 is a schematic diagram of an electronic device provided with eight antennas according to an embodiment of the disclosure.

FIG. 15 is a schematic diagram of an electronic device provided with eight antennas according to another embodiment of the disclosure.

FIG. 16 is a schematic diagram of an architecture of a wireless communication system according to a third embodiment of the disclosure with a WWAN function being disabled.

### DETAILED DESCRIPTION OF THE EMBODIMENTS

Embodiments of the disclosure are described below with reference to related drawings. Moreover, some elements or structures are omitted in drawings in the embodiments, to clearly show technical features of the disclosure. In the drawings, the same reference numerals indicate the same or similar elements or circuits. It is to be understood that although the terms “first”, “second”, and the like are used herein to describe various elements, components, regions, or functions, these elements, components, regions, and/or functions are not limited by these terms. These terms are only used to distinguish one element, component, region, or function from another element, component, region, or function.

The disclosure is to integrate antennas to be used by a wireless local area network (WLAN) module with antennas of the existing wireless wide area network (WWAN) module in an electronic device, to save an antenna design area in the electronic device, and perform switching through an internal switch device, so that the WLAN module uses the antennas of the WWAN module.

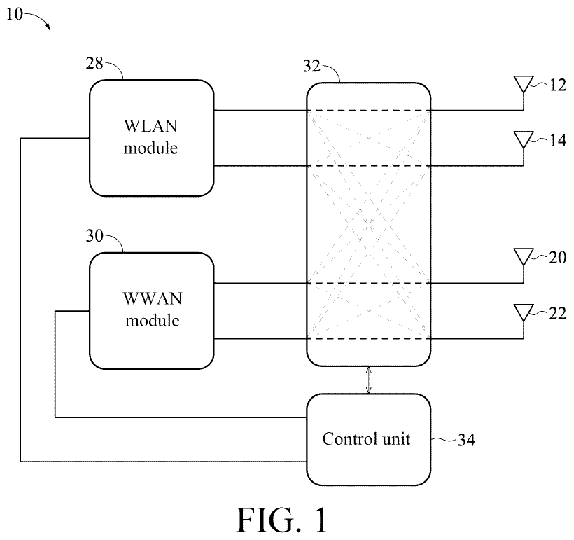

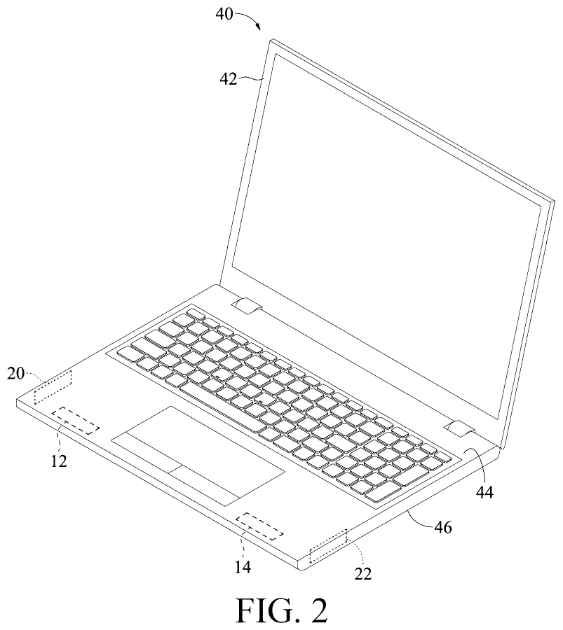

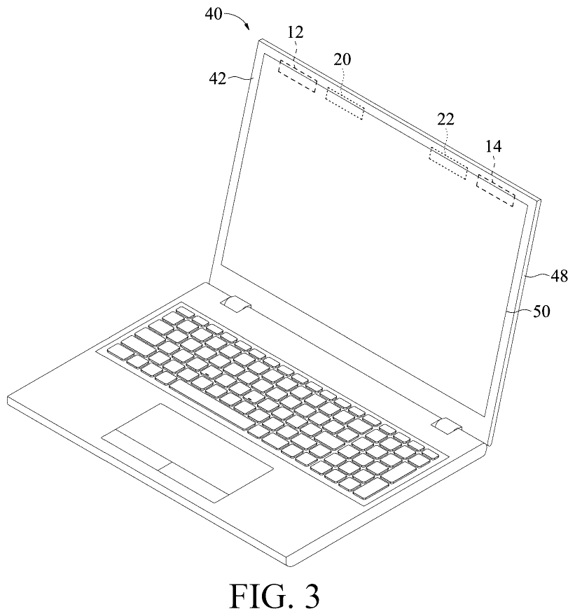

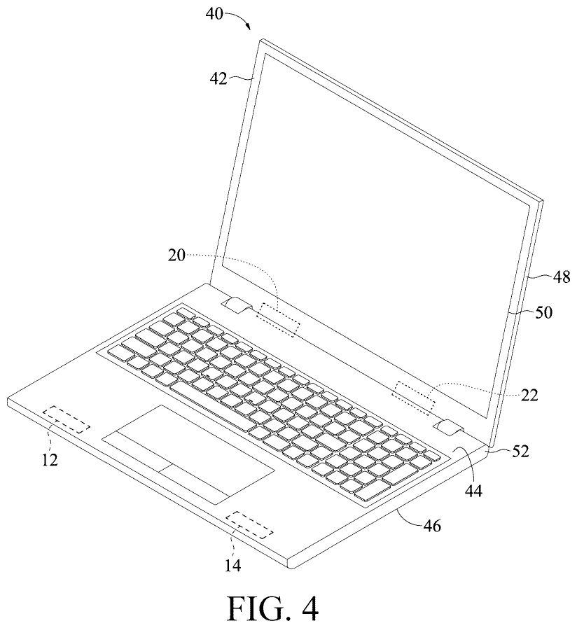

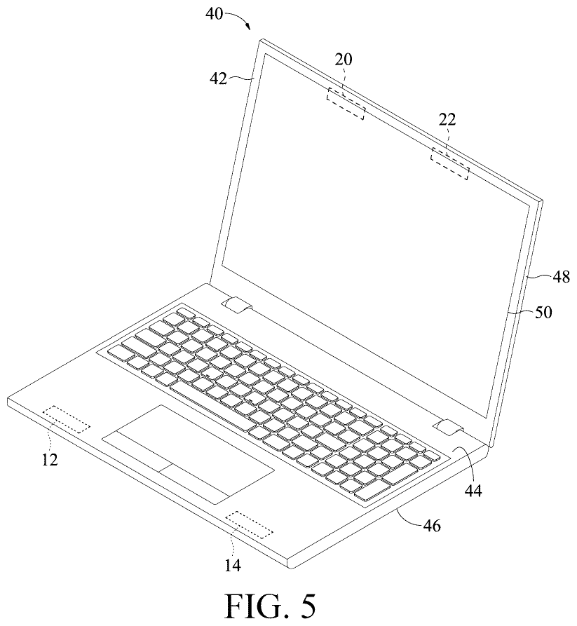

Refer to FIG. 1 and FIG. 2 to FIG. 5 together. A wireless communication system 10 is arranged in an electronic device 40. The electronic device 40 being a notebook computer is used as an example. The wireless communication system 10 includes a plurality of first antennas 12 and 14, a plurality of second antennas 20 and 22, a WLAN module 28, a WWAN module 30, a switch device 32, and a control unit 34. In the wireless communication system 10, a plurality of options is provided for configuration of the first antennas 12 and 14 and the second antennas 20 and 22. Two first antennas 12 and 14 and two second antennas 20 and 22 are used as an example. The first antennas 12 and 14 and the second antennas 20 and 22 are arranged at any appropriate position inside a housing 42 of the electronic device 40. In an embodiment, the first antennas 12 and 14 and the second antennas 20 and 22 are arranged inside a keyboard panel (part C) 44 and a bottom cover (part D) 46 of the housing 42 shown in FIG. 2. Alternatively, as shown in FIG. 3, the first antennas 12 and 14 and the second antennas 20 and 22 are arranged on a top cover (part A) 48 and a display frame (part B) 50. Alternatively, as shown in FIG. 4 and FIG. 5, the first antennas 12 and 14 and the second antennas 20 and 22 are arbitrarily arranged on the top cover 48, the display frame 50, the keyboard panel 44, the bottom cover 46, and a rotating shaft 52. However, the disclosure is not limited thereto. The following mainly describes the embodiment shown in FIG. 2. The WLAN module 28 transmits and receives a first wireless signal through first antennas 12 and 14, and the WWAN module 30 transmits and receives a second wireless signal through second antennas 20 and 22. One ends of the switch device 32 are connected to the first antennas 12 and 14 and the second antennas 20 and 22, and other ends are connected to the WLAN module 28 and the WWAN module 30. The WLAN module 28 is electrically connected to the first antennas 12 and 14 through the switch device 32. The WWAN module 30 is electrically connected to the second antennas 20 and 22 through the switch device 32. The switch device 32 selectively switches the second antennas 20 and 22 to be electrically connected to the WLAN module 28 or the WWAN module 30. The switch device 32 is a multi-pole multi-throw switch device. A four-pole four-throw (4P4T) switch device is used as an example herein. When the WWAN module 30 is turned off, the switch device 32 connects the second antennas 20 and 22 to the WLAN module 28, so that the WLAN module 28 selectively transmits and receives the first wireless signal through the first antennas 12 and 14 and the second antennas 20 and 22. In addition, the control unit 34 is electrically connected to the WLAN module 28, the WWAN module 30, and the switch device 32. The WLAN module 28 is to transmit a first current state to the control unit 34. The WWAN module 30 is also to transmit a second current state to the control unit 34. After the control unit 34 receives the first current state and the second current state, the control unit 34 is to generate a control signal based on the first current state and the second current state to control operation of the switch device 32.

In an embodiment, the WLAN module 28 is a Wi-Fi module. The first wireless signal is a Wi-Fi signal. Therefore, an operating frequency range of the first antennas 12 and 14 includes 2400 MHz to 2500 MHz and 5000 MHz to 7125 MHz of a Wi-Fi band. The WWAN module 30 is a long term evolution (LTE)/5G module. The second wireless signal is an LTE/5G signal. Moreover, since the second antennas 20 and 22 need to support the WLAN module 28 simultaneously, an operating frequency range of the second antennas 20 and 22 includes LTE/5G bands such as a low band (LB) in a range of 617 MHz to 960 MHz, a medium band (MB) in a range of 1710 MHz to 2200 MHz, a high band (HB) in a range of 2300 MHz to 2690 MHz, and an ultra-high band (UHB) in a range of 3300 MHz to 5000 MHz, and Wi-Fi bands in a range of 2400 MHz to 2500 MHz and 5000 MHz to 7125 MHz.

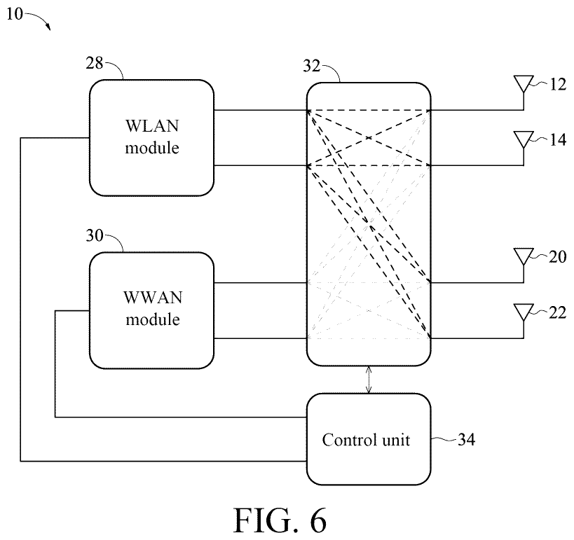

Refer to FIG. 1 and FIG. 2 together. In the wireless communication system 10, when a user enables a WLAN function and a WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (on), and control the switch device 32 to switch to a corresponding antenna. As shown in FIG. 1, the WLAN module 28 is electrically connected to the first antennas 12 and 14 through the switch device 32, and the WWAN module 30 is electrically connected to the second antennas 20 and 22 through the switch device 32. In this way, the WLAN module 28 transmits and receives the first wireless signal through the first antennas 12 and 14, and the WWAN module 30 transmits and receives the second wireless signal through the second antennas 20 and 22. Refer to FIG. 2 and FIG. 6 together. When the user enables the WLAN function and disables the WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (off), and control the switch device 32 to switch to the corresponding antenna. As shown in FIG. 6, the WLAN module 28 is electrically connected to the first antennas 12 and 14 and the second antennas 20 and 22 through the switch device 32. In this case, the first antennas 12 and 14 and the second antennas 20 and 22 all support the first wireless signal, so that the WLAN module 28 selectively transmits and receives the first wireless signal through the first antennas 12 and 14 and the second antennas 20 and 22. When the WLAN module 28 is turned on and the WWAN module 30 is turned off, the first antennas 12 and 14 and the second antennas 20 and 22 all support the transmission and receiving of the first wireless signal. In this state, the WLAN module 28 is to obtain signal strength of the first antennas 12 and 14 and the second antennas 20 and 22 when receiving a signal, and select, from the four antennas including the first antennas 12 and 14 and the second antennas 20 and 22, two antennas which are best in terms of signal strength to transmit and receive the first wireless signal. A quantity of the antennas (two antennas) which are best in terms of signal strength and selected by the WLAN module 28 is equal to a total quantity of the first antennas 12 and 14 (two antennas). Therefore, the first antennas 12 and 14 and/or the second antennas 20 and 22 used by the WLAN module 28 are to be dynamically switched based on different signal environments to choose antennas with higher signal strength.

In an embodiment, the control signal is a general-purpose input/output (GPIO) signal or a mobile industry processor interface (MIPI) signal, so that the control unit 34 controls the operation of the switch device 32 through the GPIO signal or the MIPI signal.

In an embodiment, in addition to the above notebook computer, the electronic device 40 is also a mobile phone, a personal digital assistant, a tablet computer, or the like. However, the disclosure is not limited thereto. Any portable electronic device with a mobile communication function is included in the disclosure.

In an embodiment, the control unit 34 is a central processing unit (CPU), another general-purpose or special-purpose microprocessor, a microcontroller, a micro control unit (MCU), a digital signal processor (DSP), a programmable controller, an application specific integrated circuit (ASIC), another similar element, or a combination of the foregoing elements. The disclosure is not limited thereto.

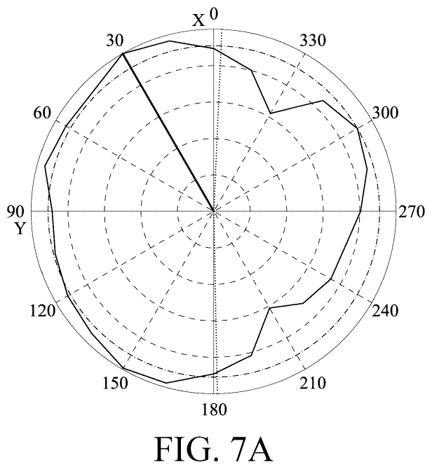

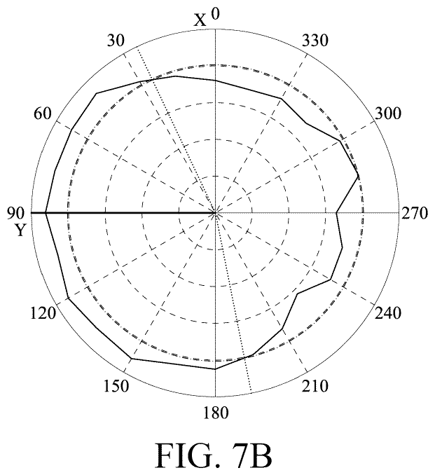

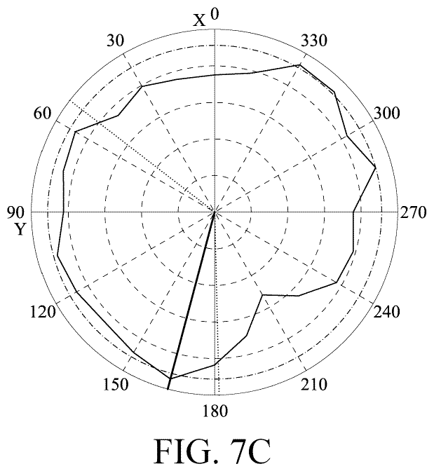

Refer to FIG. 2 and FIG. 6 together. The WLAN module 28 uses four antenna combinations such as the first antennas 12 and 14, the second antennas 20 and 22, the first antennas 12 and the second antennas 20, and the first antennas 14 and the second antennas 22, to measure the first wireless signal in a Wi-Fi 2.4G environment. Then, superposition of four antenna radiation patterns is performed, and a maximum value for each angle is obtained, to equivalently generate an antenna radiation pattern of four Wi-Fi antennas, as shown in FIG. 7A. Similarly, the first wireless signal is measured in a Wi-Fi 5G environment to obtain an antenna radiation pattern shown in FIG. 7B. The first wireless signal is measured in a Wi-Fi 6E environment to obtain an antenna radiation pattern shown in FIG. 7C. It is seen from maximum signal receiving and transmission coverages of the Wi-Fi antennas shown in the radiation patterns in FIG. 7A, FIG. 7B, and FIG. 7C that the disclosure indeed improves the coverage of the Wi-Fi antenna.

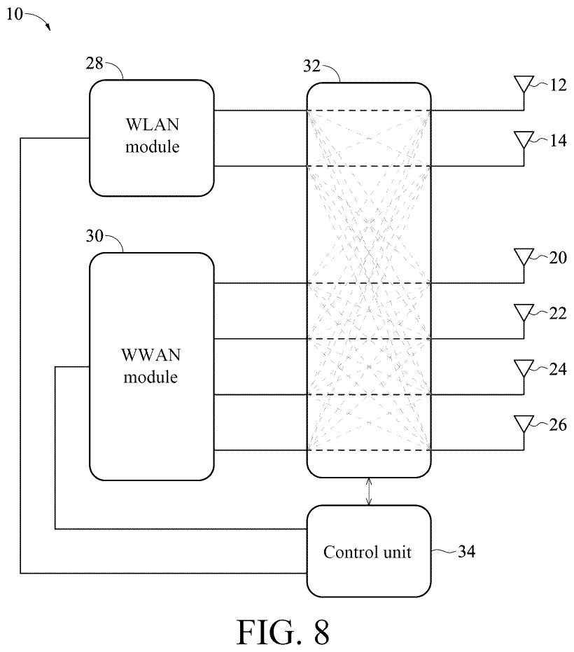

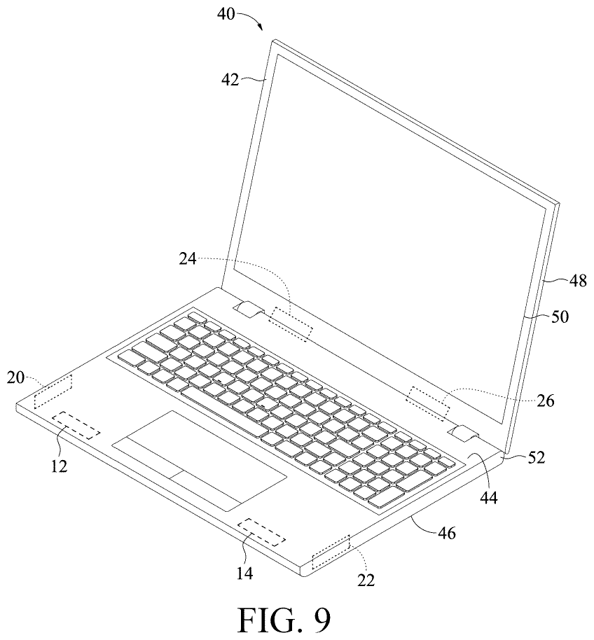

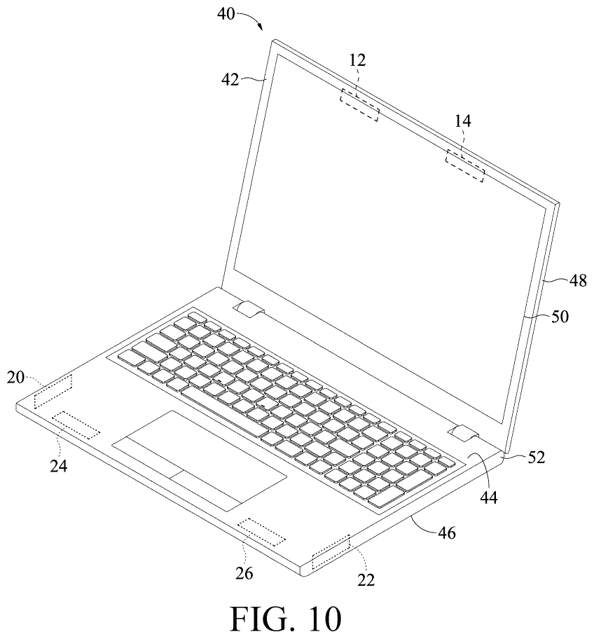

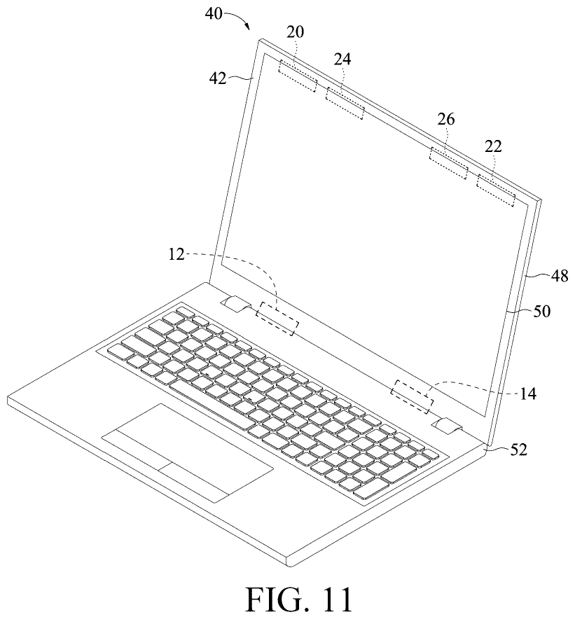

Refer to FIG. 8 and FIG. 9 together. A wireless communication system 10 is arranged in an electronic device. A notebook computer is used as an example herein. In this embodiment, the wireless communication system 10 includes two first antennas 12 and 14, four second antennas 20, 22, 24, and 26, a WLAN module 28, a WWAN module 30, a switch device 32, and a control unit 34. A plurality of options is provided for configuration of the first antennas 12 and 14 and the second antennas 20, 22, 24, and 26. The first antennas and the second antennas are to be arranged any position inside a housing 42 of an electronic device 40. In an embodiment, the first antennas 12 and 14 and the second antennas 20, 22, 24, and 26 are arranged on a keyboard panel 44, a bottom cover 46, and a rotating shaft 52 of the housing 42 shown in FIG. 9. Alternatively, as shown in FIG. 10, the first antennas 12 and 14 and the second antennas 20, 22, 24, and 26 are arbitrarily arranged on a top cover 48, a display frame 50, the keyboard panel 44, and the bottom cover 46. Alternatively, as shown in FIG. 11, the first antennas 12 and 14 and the second antennas 20, 22, 24, and 26 are arbitrarily arranged on the top cover 48, the display frame 50, and the rotating shaft 52. However, the disclosure is not limited thereto. The following mainly describes the embodiment shown in FIG. 9. As shown in FIG. 8 and FIG. 9, the WLAN module 28 transmits and receives a first wireless signal through the first antennas 12 and 14, and the WWAN module 30 transmits and receives a second wireless signal through the second antennas 20, 22, 24, and 26. One ends of the switch device 32 are connected to the first antennas 12 and 14 and the second antennas 20, 22, 24, and 26, and other ends are connected to the WLAN module 28 and the WWAN module 30. The WLAN module 28 is electrically connected to the first antennas 12 and 14 through the switch device 32. The WWAN module 30 is electrically connected to the second antennas 20, 22, 24, and 26 through the switch device 32. The switch device 32 selectively switches the second antennas 20, 22, 24, and 26 to be electrically connected to the WLAN module 28 or the WWAN module 30. An example in which the switch device 32 is a six-pole six-throw (6P6T) switch device is used. In addition, the control unit 34 is electrically connected to the WLAN module 28, the WWAN module 30, and the switch device 32. The control unit 34 is to generate a control signal based on a first current state of the WLAN module 28 and a second current state of the WWAN module 30 to control operation of the switch device 32.

Refer to FIG. 8 and FIG. 9 together. In the wireless communication system 10, when a user enables a WLAN function and a WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (on), and control the switch device 32 to switch to a corresponding antenna. As shown in FIG. 8, the WLAN module 28 is electrically connected to the first antennas 12 and 14 through the switch device 32, and the WWAN module 30 is electrically connected to the second antennas 20, 22, 24, and 26 through the switch device 32. In this way, the WLAN module 28 transmits and receives the first wireless signal through the first antennas 12 and 14, and the WWAN module 30 transmits and receives the second wireless signal through the second antennas 20, 22, 24, and 26.

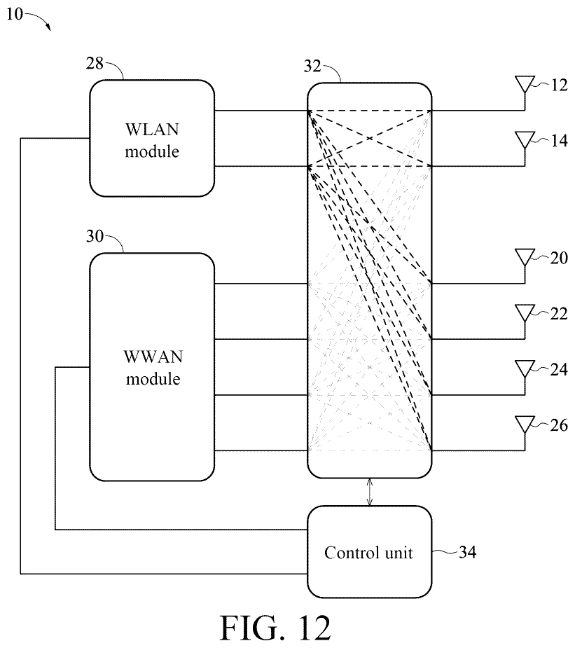

Refer to FIG. 9 and FIG. 12 together. When the user enables the WLAN function and disables the WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (off), and control the switch device 32 to switch to the corresponding antenna. As shown in FIG. 12, the WLAN module 28 is electrically connected to the first antennas 12 and 14 and the second antennas 20, 22, 24, and 26 through the switch device 32, so that the WLAN module 28 selectively transmits and receives the first wireless signal through the first antennas 12 and 14 and the second antennas 20, 22, 24, and 26. When the WLAN module 28 is turned on and the WWAN module 30 is turned off, the first antennas 12 and 14 and the second antennas 20, 22, 24, and 26 all support the transmission and receiving of the first wireless signal. In this state, the WLAN module 28 is to first obtain signal strength of the first antennas 12 and 14 and the second antennas 20, 22, 24, and 26 when receiving a signal, and select, from the six antennas including the first antennas 12 and 14 and the second antennas 20, 22, 24, and 26, two antennas which are best in terms of signal strength to transmit and receive the first wireless signal. Therefore, the first antennas 12 and 14 and/or the second antennas 20, 22, 24, and 26 used by the WLAN module 28 are to be dynamically switched based on different signal environments to choose antennas with higher signal strength. Due to a fact that the disclosure is to select, from the six antennas (the first antennas 12 and 14 and the second antennas 20, 22, 24, and 26), two antennas which are best in terms of signal strength to transmit and receive the first wireless signal, which is equivalent to superimposition of six antenna radiation patterns, and a maximum value for each angle is obtained. Therefore, a receiving and transmitting coverage of the first wireless signal (a Wi-Fi signal) is effectively improved.

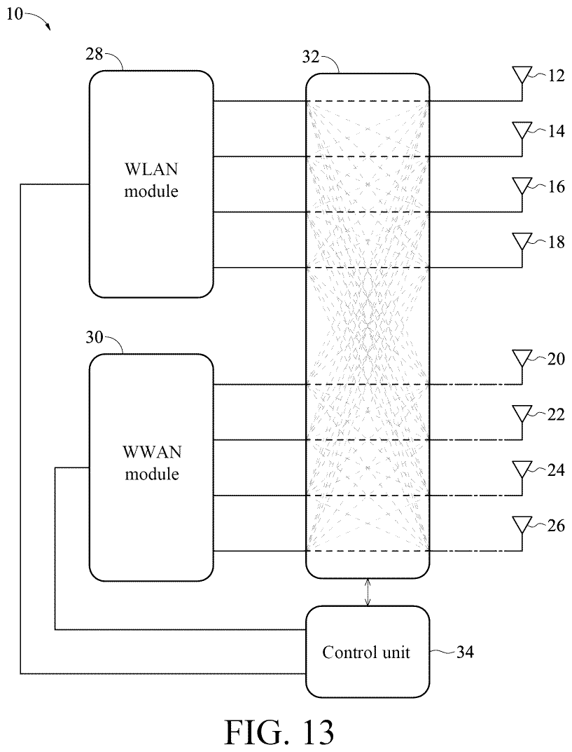

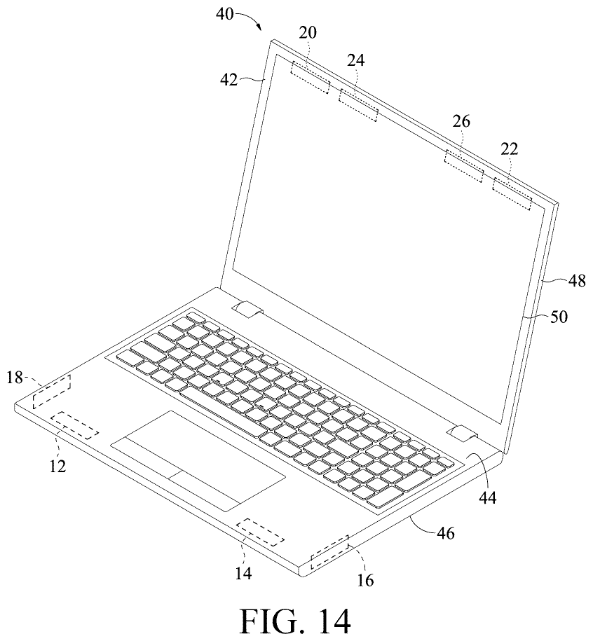

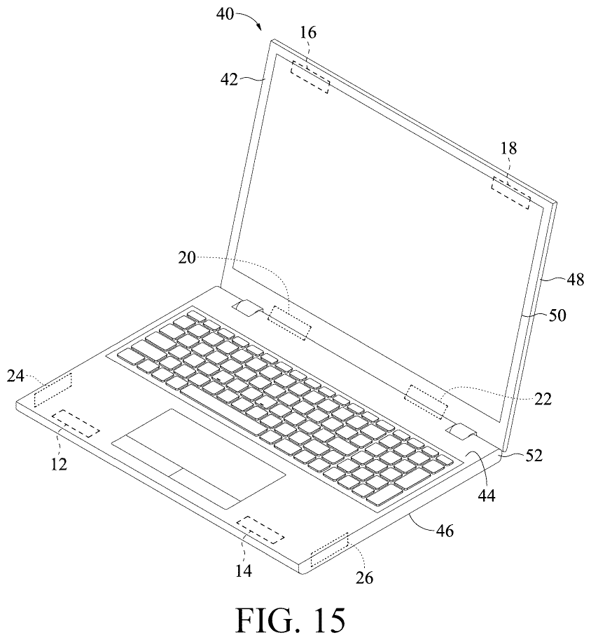

Refer to FIG. 13 and FIG. 14 together. A wireless communication system 10 is arranged in an electronic device 40. A notebook computer is used as an example herein. In this embodiment, the wireless communication system 10 includes four first antennas 12, 14, 16, and 18, four second antennas 20, 22, 24, and 26, a WLAN module 28, a WWAN module 30, a switch device 32, and a control unit 34. A plurality of options is provided for configuration of the first antennas 12, 14, 16, and 18 and the second antennas 20, 22, 24, and 26. The first antennas and the second antennas are to be arranged any position inside a housing 42 of the electronic device 40. In an embodiment, the first antennas 12, 14, 16, and 18 and the second antennas 20, 22, 24, and 26 are arranged on a keyboard panel 44, a bottom cover 46, a top cover 48, and a display frame 50 of the housing 42 shown in FIG. 14. Alternatively, as shown in FIG. 15, the first antennas 12, 14, 16, and 18 and the second antennas 20, 22, 24, and 26 are arbitrarily arranged on the keyboard panel 44, the bottom cover 46, the top cover 48, the display frame 50, and a rotating shaft 52. However, the disclosure is not limited thereto. The following mainly describes the embodiment shown in FIG. 14. As shown in FIG. 13 and FIG. 14, the WLAN module 28 transmits and receives a first wireless signal through the first antennas 12, 14, 16, and 18, and the WWAN module 30 transmits and receives a second wireless signal through the second antennas 20, 22, 24, and 26. One ends of the switch device 32 are connected to the first antennas 12, 14, 16, and 18 and the second antennas 20, 22, 24, and 26, and other ends are connected to the WLAN module 28 and the WWAN module 30. The WLAN module 28 is electrically connected to the first antennas 12, 14, 16, and 18 through the switch device 32. The WWAN module 30 is electrically connected to the second antennas 20, 22, 24, and 26 through the switch device 32. The switch device 32 selectively switches the second antennas 20, 22, 24, and 26 to be electrically connected to the WLAN module 28 or the WWAN module 30. An example in which the switch device 32 is an eight-pole eight-throw (8P8T) switch device is used. In addition, the control unit 34 is electrically connected to the WLAN module 28, the WWAN module 30, and the switch device 32. The control unit 34 is to generate a control signal based on a first current state of the WLAN module 28 and a second current state of the WWAN module 30 to control operation of the switch device 32.

Refer to FIG. 13 and FIG. 14 together. In the wireless communication system 10, when a user enables a WLAN function and a WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (on), and control the switch device 32 to switch to a corresponding antenna. As shown in FIG. 13, the WLAN module 28 is electrically connected to the first antennas 12, 14, 16, and 18 through the switch device 32, and the WWAN module 30 is electrically connected to the second antennas 20, 22, 24, and 26 through the switch device 32. In this way, the WLAN module 28 transmits and receives the first wireless signal through the first antennas 12, 14, 16, and 18, and the WWAN module 30 transmits and receives the second wireless signal through the second antennas 20, 22, 24, and 26.

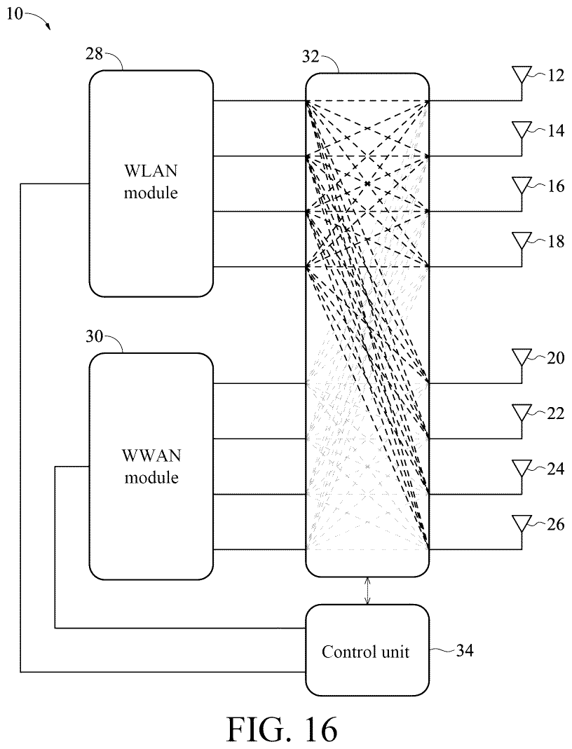

Refer to FIG. 14 and FIG. 16 together. When the user enables the WLAN function and disables the WWAN function, the WLAN module 28 is to transmit the first current state that is an on state to the control unit 34, and the WWAN module 30 is to transmit the second current state that is an on state to the control unit 34. The control unit 34 is to generate and transmit a control signal to the switch device 32 based on the first current state (on) and the second current state (off), and control the switch device 32 to switch to the corresponding antenna. As shown in FIG. 16, the WLAN module 28 is electrically connected to the first antennas 12, 14, 16, and 18 and the second antennas 20, 22, 24, and 26 through the switch device 32, so that the WLAN module 28 selectively transmits and receives the first wireless signal through the first antennas 12, 14, 16, and 18 and the second antennas 20, 22, 24, and 26. When the WLAN module 28 is turned on and the WWAN module 30 is turned off, the first antennas 12, 14, 16, and 18 and the second antennas 20, 22, 24, and 26 all support the transmission and receiving of the first wireless signal. In this state, the WLAN module 28 is to first obtain signal strength of the first antennas 12, 14, 16, and 18 and the second antennas 20, 22, 24, and 26 when receiving a signal, and select, from the eight antennas including the first antennas 12, 14, 16, and 18 and the second antennas 20, 22, 24, and 26, four antennas which are best in terms of signal strength to transmit and receive the first wireless signal. A quantity of the antennas (four antennas) which are best in terms of signal strength and selected by the WLAN module 28 is equal to a total quantity of the first antennas 12, 14, 16, and 18 (four antennas). Therefore, the first antennas 12, 14, 16, and 18 and/or the second antennas 20, 22, 24, and 26 used by the WLAN module 28 are to be dynamically switched based on different signal environments to choose antennas with higher signal strength. Due to a fact that the disclosure is to select, from the eight antennas (the first antennas 12, 14, 16, and 18 and the second antennas 20, 22, 24, and 26), four antennas which are best in terms of signal strength to transmit and receive the first wireless signal, which is equivalent to superimposition of eight antenna radiation patterns, and a maximum value for each angle is obtained. Therefore, a receiving and transmitting coverage of the first wireless signal (a Wi-Fi signal) is effectively improved.

In an embodiment, as shown in FIG. 1, FIG. 6, FIG. 8, FIG. 12, FIG. 13, and FIG. 16, the switch device 32 uses the multi-pole multi-throw (xPxT) switch device, and is a mechanical electronic switch or a semiconductor switch.

Based on the above, the disclosure provides a wireless communication system that effectively utilizes idle antennas of the WWAN module without increasing an antenna size and space, and changes the antennas to antennas of the WLAN module to receive and transmit a signal. Therefore, a signal receiving and transmission range of the WWAN signal and the WLAN signal is effectively increased, so as to increase a coverage (a coverage rate) of a wireless network signal.

The foregoing embodiments are merely for describing the technical ideas and the characteristics of the disclosure, which are intended to enable a person skilled in the art to understand and implement the content of the disclosure accordingly, and do not constitute a limitation on the patent scope of the disclosure. In other words, equivalent changes or modifications made to the spirit disclosed in the disclosure still fall within the scope of the patent application of the disclosure.

What is claimed is:

1. A wireless communication system, arranged within an electronic device, and comprising:
a plurality of first antennas;
a plurality of second antennas;
a wireless local area network (WLAN) module, configured to transmit and receive a first wireless signal through the first antennas;
a wireless wide area network (WWAN) module, configured to transmit and receive a second wireless signal through the second antennas; and
a switch device, comprising one ends connected to the first antennas and the second antennas, and other ends connected to the WLAN module and the WWAN module, wherein the WLAN module is electrically connected to the first antennas through the switch device, the switch device is configured to selectively switch the second antennas to be electrically connected to the WLAN module or the WWAN module, and when the WWAN module is turned off, the switch device connects the second antennas to the WLAN module, so that the WLAN module selectively transmits and receives the first wireless signal through the first antennas and the second antennas.

2. The wireless communication system according to claim 1, wherein the WLAN module is a Wi-Fi module, and the first wireless signal is a Wi-Fi signal.

3. The wireless communication system according to claim 1, wherein the WWAN module is a long term evolution (LTE)/5G module, and the second wireless signal is an LTE/5G signal.

4. The wireless communication system according to claim 1, wherein when the WWAN module is turned off, the WLAN module obtains signal strength of the first antennas and the second antennas, and selects, from the first antennas and the second antennas, at least two antennas which are best in terms of signal strength to transmit and receive the first wireless signal.

5. The wireless communication system according to claim 4, wherein a quantity of the at least two antennas which are best in terms of signal strength and selected by the WLAN module from the first antennas and the second antennas is equal to a total quantity of the first antennas.

6. The wireless communication system according to claim 1, further comprising a control unit that is electrically connected to the WLAN module, the WWAN module, and the switch device, wherein the WLAN module is configured to transmit a first current state to the control unit, and the WWAN module is configured to transmit a second current state to the control unit, so that the control unit generates a control signal based on the first current state and the second current state to control operation of the switch device.

7. The wireless communication system according to claim 6, wherein when the first current state is on and the second current state is off, the control unit generates the control signal to control the switch device to connect the WLAN module to the first antennas and connect the WLAN module to the second antennas, so that the WLAN module selectively transmits and receives the first wireless signal through the first antennas and the second antennas.

8. The wireless communication system according to claim 6, wherein the control signal is a general-purpose input/output (GPIO) signal or a mobile industry processor interface (MIPI) signal.

9. The wireless communication system according to claim 6, wherein the switch device is a multi-pole multi-throw switch device.

10. The wireless communication system according to claim 1, wherein the first antennas and the second antennas are respectively arranged on a housing of the electronic device.

11. The wireless communication system according to claim 1, wherein an operating frequency range of the first antennas comprises 2400 MHz to 2500 MHz and 5000 MHz to 7125 MHz.

12. The wireless communication system according to claim 1, wherein an operating frequency range of the second antennas comprises LTE/5G bands such as a low band (LB) in a range of 617 MHz to 960 MHz, a medium band (MB) in a range of 1710 MHz to 2200 MHz, a high band (HB) in a range of 2300 MHz to 2690 MHz, and an ultra-high band (UHB) in a range of 3300 MHz to 5000 MHz, and Wi-Fi bands in a range of 2400 MHz to 2500 MHz and 5000 MHz to 7125 MHz.
